(19) United States
(12) Patent Application Publication
(10) Pub. No.: US 2026/0057174 A1
(43) Pub. Date: Feb. 26, 2026

(54) TRAINING DATA FILTRATION FOR LARGE LANGUAGE MODELS

(71) Applicant: International Business Machines Corporation, Armonk, NY (US)

(72) Inventors: Hajar Emami Gohari, Plano, TX (US); Xuan-Hong Dang, Chappaqua, NY (US); Petros ZERFOS, New York, NY (US)

(73) Assignee: International Business Machines Corporation, Armonk, NY (US)

(21) Appl. No.: 18/813,615

(22) Filed: Aug. 23, 2024

(51) Int. Cl. G06F 40/284; G06F 16/383

(52) U.S. Cl. CPC G06F 40/284; G06F 16/383

(57) ABSTRACT

An embodiment samples raw data pertaining to a domain to form sample domain data, which includes a set of documents. A first pre-tokenization attribute of a first document in the set is computed. The first document is tokenized to generate a first set of tokens corresponding to the first document. A first post-tokenization attribute of the first document is computed. The first document is positioned in a statistical distribution of the set of documents according to a ratio of a pre-tokenization attribute and a post-tokenization attribute of each document in the set. a subset of documents including the first document is selected, from the statistical distribution such that each member of the subset has a value of the corresponding ratio below a first threshold configured for the distribution. The subset is filtered out from the sample domain data to form filtered data. A model is trained using filtered data.

### BACKGROUND

The present invention relates generally to the field of artificial intelligence using Large Language Models, automatic machine learning, and data science. More particularly, the present invention relates to a method, system, and computer program for training data filtration for LLMs.

Artificial intelligence (AI) technology has evolved significantly over the past few years. Modern AI systems are achieving human-level performance on cognitive tasks like converting speech to text, recognizing objects and images, and translating between different languages. This evolution holds promise for new and improved applications in many industries.

A Large Language Model (LLM or model, plural LLMs or models) is a type of software designed to understand and generate human-like text. LLMs are trained on massive amounts of data from books, articles, websites, and other written sources. At their core, LLMs use a neural network in a transformer architecture that has layers of interconnected nodes that process and interpret text data. An Artificial Neural Network (ANN) is a computing system made up of a number of simple, highly interconnected processing elements, which process information by their dynamic state response to external inputs. ANNs are processing devices (algorithms and/or hardware) that are loosely modeled after the neuronal structure of the mammalian cerebral cortex but on smaller scales. A large ANN implementation of an LLM might have tens of millions of interconnected nodes. By comparison, a mammalian brain has billions of neurons with a corresponding increase in the magnitude of their overall interaction and emergent behavior.

Conventional AI techniques use large data sets to train LLMs and use the trained LLM to identify patterns and draw conclusions in response to inputs. For example, LLMs can analyze the context of the words in a sentence or passage by looking at how words relate to each other in terms of meaning and usage and generate relevant and coherent responses.

AI systems also use LLMs as predictive models to perform these functions under different or changing conditions. When given a prompt or question, a model predicts what comes next based on the patterns learned during training. This prediction is generally made word by word, generating responses that aim to be contextually appropriate and informative. After the initial training, LLMs can be fine-tuned on specific types of text or for particular tasks to improve their performance in those areas. LLMs are designed to mimic human language abilities for tasks like answering questions, writing content, or translating languages.

### SUMMARY

The illustrative embodiments provide for training data filtration for large language models. An embodiment includes sampling to form sample domain data from raw data representative data pertaining to a domain, wherein the sample domain data comprises a set of documents. The embodiment includes computing a first pre-tokenization attribute of a first document in the set of documents. The embodiment includes tokenizing the first document, the tokenizing generating a first set of tokens corresponding to the first document. The embodiment includes computing a first post-tokenization attribute of the first document. The embodiment includes positioning the first document in a statistical distribution of the set of documents, wherein the statistical distribution is according to a ratio of a pre-tokenization attribute and a post-tokenization attribute of each document in the set of documents. The embodiment includes selecting, from the statistical distribution, a subset of documents such that each member of the subset has a value of the corresponding ratio and the value is below a first threshold configured for the statistical distribution, the subset comprising the first document. The embodiment includes filtering out the subset of documents from the sample domain data such that a second subset comprising documents remaining in the sample domain data after the filtering comprises filtered data. The embodiment includes training a model using filtered data.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example data preprocessing operation for preparing data for extreme filtration application 200 of FIG. 1 in accordance with an illustrative embodiment;

FIG. 3 depicts an example configuration of an extreme filtration application in accordance with an illustrative embodiment;

FIG. 4 depicts a block diagram of an example operation of an extreme filtration application in accordance with an illustrative embodiment;

FIG. 5 depicts one example process for improved LLM training using filtered data in accordance with an illustrative embodiment;

FIG. 6 depicts another example process for improved LLM training in accordance with an illustrative embodiment;

FIG. 7 depicts a flowchart of an example process for training data filtration for large language models in accordance with an illustrative embodiment;

FIG. 8 depicts a flowchart of an example process for training data filtration for large language models in accordance with an illustrative embodiment;

FIG. 9 depicts a flowchart of an example process for generating optimal thresholds in accordance with an illustrative embodiment;

FIG. 10 depicts a process for training data filtration for large language models in accordance with an illustrative embodiment;

FIG. 11 depicts a process for identifying low-quality documents in accordance with an illustrative embodiment;

FIG. 12 depicts a document distribution usable in accordance with an illustrative embodiment;

FIG. 13 depicts an example operation using the document distribution depicted in FIG. 12 in accordance with an illustrative embodiment; and

FIG. 14 depicts the comparative results of training two LLMs using a filtered version and a non-filtered version of several data sets in accordance with an illustrative embodiment.

### DETAILED DESCRIPTION

The quality of an output of an LLM is highly dependent on the training of that LLM. Particularly, the quality of the data used to train an LLM can directly impact the quality—in terms of accuracy, applicability, currency, contextual appropriateness—of the output.

The illustrative embodiments recognize that the quality of data used to train LLMs becomes fundamental to their ability to comprehend and generate human-like text, uphold reliability, and promote fairness by mitigating bias. The illustrative embodiments recognize that the quality of the training data is one of the decisive factors in determining the performance of a language model. For example, the illustrative embodiments recognize that the training data quality improves an LLM's capacity for generalization and cost efficiency by minimizing the necessity for retraining.

The illustrative embodiments recognize that high-quality training data can ensure that LLMs produce reliable information, avoiding or alleviating misleading generated outputs. Better training data leads to better trained models, better business insights, and can directly impact a business's profitability.

The illustrative embodiments further recognize that better quality of training data can reduce the overall size of the training data and consequently reduce the computation resource needed to train LLMs. As an example, the illustrative embodiments recognize that smaller but more effectively selected training data can train the same model with less data, less energy, and less retraining, thereby contributing significantly towards reducing the environmental costs of AI. Therefore, the illustrative embodiments recognize that investing in and improving LLM training data quality is highly desirable in AI-driven initiatives.

Presently, some methods exist for reducing the training data, improving the quality of the training data, or both, and these methods have certain limitations and/or disadvantages that are solved, reduced, remedied, or alleviated by the illustrative embodiments described herein. For example, certain existing methods are limited to deduplication, removal of very small documents based on threshold document size or word count for inclusion in the training data, mean word size, symbol-to-word ratio, normalization of paragraphs in style, redundancy of content, or some combination of these and other such heuristics. The illustrative embodiments recognize that the present methods only look at the raw data when applying these heuristics and are therefore frequently unsuccessful in filtering out certain documents from the raw data corpus, which can be of marginal value as training data yet escape these heuristics and get included in the training data.

The illustrative embodiments address the deficiencies described herein and provide a process (as well as a system, method, and computer program product embodied in a machine-readable medium) for filtering the data collected for training an LLM. An embodiment can be used in conjunction with or as a substitute for an existing method for training data filtration. The illustrative embodiments utilize techniques described herein for the filtration of training data using not just the raw data but also tokenized data resulting therefrom. The combination of raw data and tokenized data, when used in a manner described herein, provides an improved manner of filtration of the training data for the benefits and advantages of LLM training, as described herein.

The illustrative embodiments provide for training data filtration for large language models. Filtration or filtering, as referred to herein, is a manner of identifying and avoiding the inclusion of an undesirable document, or conversely, identifying and including a desirable document, in a data set that is going to be used in training an LLM. The method(s) for identification and avoidance or inclusion are described using several embodiments, using nonlimiting examples, data, and drawings. Embodiments are disclosed herein with reference to Large Language Models as the term is understood presently—an ANN comprising millions of nodes. However, the use of this example size is not intended to be limiting but is instead used for descriptive purposes only. The illustrative embodiments can be used to filter any corpus of data in a similar manner without departing from the scope of the illustrative embodiments, whether used in conjunction with an LLM, a smaller model, or other AI applications.

An embodiment forms a corpus of raw data which is collected from a variety of sources for the purpose of training an LLM. The raw data comprises documents containing information in textual form, graphical form, visual representation, and even audio-visual form. Some example sources of such data are data marts, data libraries, data available on the internet or intranet, or some combination thereof.

The embodiment identifies, using one or more known methods, one or more knowledge domains (domain) to which a document in the raw data corpus pertains. Processing the raw data in this manner, the embodiment creates domain data for one or more domains from the raw data corpus. For example, documents pertaining to financial information may be classified under the “Financial” domain, whereas a source code file might be classified under a “Code” domain.

An embodiment further applies one or more techniques to categorize the raw data within a domain (raw domain data). For example, one embodiment uses a clustering technique to identify one or more categories in which the raw domain data of a particular domain might be separated. As an example, raw domain data of “Code” domain can be further categorized into “Java”, “C++”, “Python” and other language categories. A category might have one or more subcategories, and the depth of categorization may be any number of levels deep. Without implying any limitation, any number of domains, categories as well as subcategories may be applied to the raw data corpus.

The raw domain data of one or more domains—with or without any categories or subcategories-forms an input to an illustrative embodiment that may be implemented as an Extreme Filtration Application-a software application executing on a computing hardware. The extreme filtration application filters out certain documents from the raw data corpus in a manner described herein and produces filtered data. The filtered data is usable for training a model as described herein.

in one embodiment, the extreme filtration application comprises a data sampler. The data sampler samples the raw domain data of a domain to extract a representative sample of the raw domain data of the domain. The sample raw domain data is just a smaller data set from the raw domain data of the domain, such that the sample maintains substantially the same distribution, range, scope, and other attributes of the information contained in the raw domain data of that domain.

Tokenization in AI, particularly in the context of natural language processing (NLP) and LLMs, is the process of breaking down text into smaller units called tokens. These tokens are the building blocks that a model uses to understand and generate language. Tokens can be individual words, parts of words (subwords), or even characters, depending on the tokenization strategy used. For example, the sentence “filtering data for AI” might be tokenized into the tokens “filtering,” “data,” “for,” and “AI” if using word-level tokenization. Alternatively, with subword tokenization, it might be broken down into smaller parts like “filter,” “ing,” “data,” “for,” “A,” and “I.” By breaking down text into tokens, models can handle text more systematically and apply algorithms to understand patterns and generate responses.

There are various types of tokenization presently used with LLMs. For example, word-level tokenization splits text into words. Subword tokenization breaks words into smaller units (subwords or word pieces). Character-level tokenization splits text into individual characters. Special tokens might be used for specific purposes, such as indicating the start or end of a sentence or separating different parts of input.

An embodiment tokenizes the sample raw domain data using one or more tokenization techniques. In one embodiment, tokenization is implemented as a component of the extreme filtration application. In another embodiment, tokenization is a service provided by other applications and used by the extreme filtration application via an interface to one or more of such external tokenizers or tokenization applications.

In one embodiment, for a document in the sample raw domain data, a component in the extreme filtration application computes a tokens-per-byte ratio (T/B ratio). Tokens-per-byte ratio of a document is a ratio of a number of tokens identified in that document and the number of bytes present in the raw data form of that document. In other words, the tokens-per-byte ratio of a document utilizes one type of pre-tokenization information of that document together with the post-tokenization information of that document to compute the ratio. Thus, the illustrative embodiments utilize information from two different stages of text data pre-processing for automatically identifying and filtering out low-quality documents based on tokenized data used in LLM training.

In another embodiment, for a document in the sample raw domain data, a component in the extreme filtration application computes a tokens-per-character ratio (T/C ratio). Tokens-per-character ratio of a document is a ratio of a number of tokens identified in that document and the number of characters present in the raw data form of that document. In other words, the tokens-per-character ratio of a document utilizes a different pre-tokenization information of that document together with the post-tokenization information of that document to compute the ratio. Thus, the illustrative embodiments utilize information from two different stages of text data pre-processing for automatically identifying and filtering out low-quality documents based on tokenized data used in LLM training.

The illustrative embodiments utilize tokens-per-byte ratio, tokens-per-character ratio, or both to remove those documents from the sample raw domain data that can be regarded as being of low quality. Some nonlimiting examples of low quality documents include, but are not limited to documents containing solely or more than a threshold amount of—digits and/or symbols, mixed languages content, date and time entries, dots or unresolved symbols, words with space between characters, URL links, unusual symbols, emoji, icons, or some combination of these and other representations that are determined to be of marginal training value.

For example, in one embodiment, a component computes a distribution of the documents according to the tokens-per-byte ratio, tokens-per-character ratio, or some combination thereof. For example, one nonlimiting example of the distribution may be a Gaussian distribution. The documents lying on either of the extreme ends of the Gaussian distribution may be regarded as low quality docs. Specifically, the documents lying beyond a threshold distance on either side from the mean of the Gaussian distribution may be regarded as the documents lying at the extremes-hence the reference to extreme filtration application, which filters the documents at the extremes of a distribution.

another nonlimiting example of the distribution may be a ranked or ordered list of documents that is ordered according to tokens-per-byte ratio, tokens-per-character ratio, or some combination thereof. The documents lying on one extreme or end of the list may be regarded as low quality docs. Specifically, the documents lying beyond a threshold level in the ordered list may be regarded as the documents lying at the low quality extreme and may be removed from the sample raw domain data. Many other ways of identifying documents lying at the extreme(s) of a different type of tokens-per-byte ratio or tokens-per-character ratio based distribution will be apparent from this disclosure to those of ordinary skill in the art and the same are contemplated within the scope of the illustrative embodiments.

A component in the extreme filtration application of an illustrative embodiment can be configured to perform one or more of the different types of distribution, ranking, or ordering of the documents based on the tokens-per-byte ratio, tokens-per-character ratio, or some combination thereof. Alternatively, different components can be configured in the extreme filtration application of an illustrative embodiment to perform the different distribution, ranking, or ordering of the documents based on the tokens-per-byte ratio, tokens-per-character ratio, or some combination thereof.

In order to identify the extremes, a component of an extreme filtration application according to an illustrative embodiment uses one or more threshold values. The number of threshold values is dependent on the type of distribution used, as described herein.

In one embodiment, a threshold value is supplied as an input to the extreme filtration application. For example, a profile setup, a default value, or a user input may be used in this manner to configure a threshold for an extreme.

In another embodiment, a threshold value is computed using the characteristics of the distribution. For example, a Gaussian distribution's standard deviation from the mean value may be used to set up one or both thresholds. For example, the left or lower threshold may be a single standard deviation away from the mean, and the right or upper threshold may be the same number or a different number of standard deviations away from the mean.

Using the one or more thresholds, an embodiment removes those documents from the sample raw domain data that fail to meet the threshold. The reduced sample raw domain data resulting from the removal is the filtered data. The filtered data is the reduced training data set that essentially retains the desirable documents from the raw domain data and removes the undesirable or low-quality documents from the raw domain data.

It is desirable that the filtered data maintain sufficient resemblance and representation of the raw data corpus while improving a characteristic of the output of an LLM that uses the filtered data for training.

In another embodiment, a threshold value for extreme data removal is computed using a feedback from the LLM that is used to test the quality of the filtered data. A component iteratively sets a threshold value, produces corresponding filtered data, and adjusts the threshold value depending on whether the test LLM indicates an improvement or worsening in the output using the resulting filtered data.

In another embodiment, a threshold value for extreme data removal is computed using a feedback from the LLM that is ultimately trained using the filtered data. A component iteratively sets a threshold value, produces corresponding filtered data, and adjusts the threshold value depending on whether the actual (or production) LLM indicates an improvement or worsening in the output using the resulting filtered data.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

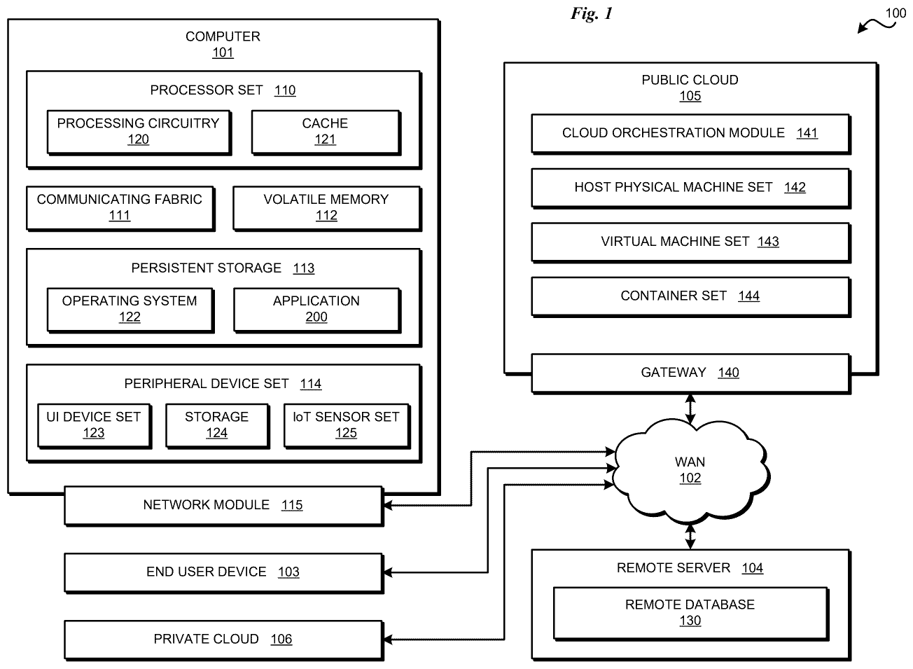

With reference to FIG. 1, this figure depicts a block diagram of a computing environment 100. Computing environment 100 contains an example of an environment for the execution of at least some of the computer code involved in performing the inventive methods, such as an extreme filtration application 200 that implements one or more embodiments for training data filtration for large language models as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

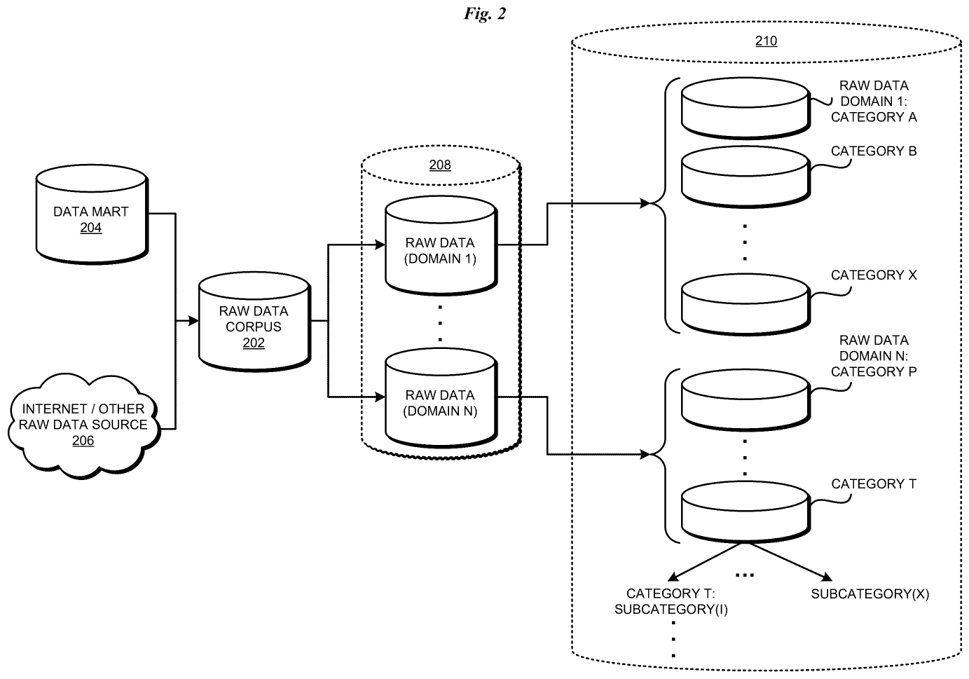

With reference to FIG. 2, this figure depicts a block diagram of an example data preprocessing operation for preparing data for extreme filtration application 200 of FIG. 1 in accordance with an illustrative embodiment. Data 202 is the raw data corpus described herein, and can be sourced from any type and number of data sources, for example, data mart 204 and/or Internet or other raw data source 206. One or more domains are identified in Raw data corpus 202 to form raw domain data 208. For example, raw domain data 208 may comprise raw data pertaining to domain 1 through domain n. Raw domain data 210 is a further optional form of raw domain data 208 in which one or more categories and one or more subcategories have been identified and appropriately flagged or marshaled. For example, raw domain data 210 is shown to include categories A-X for domain 1, and so on till domain n having categories P-T with category T having subcategories (i)-(x), and so on.

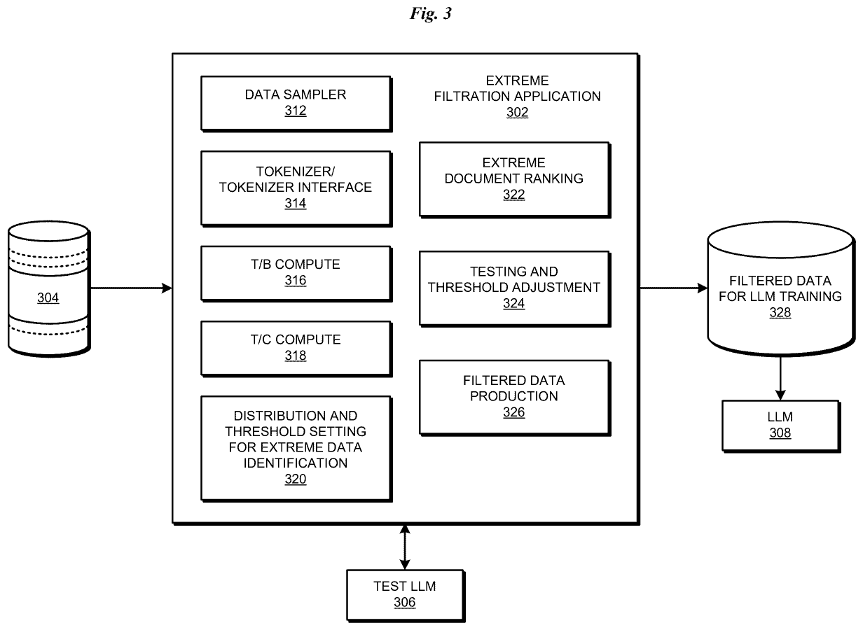

With reference to FIG. 3, this figure depicts an example configuration of an extreme filtration application in accordance with illustrative embodiments. Extreme filtration application 302 is an example of extreme filtration application 200 in FIG. 1. Input data 304 can be an example of raw data corpus 202, raw domain data 208, or raw domain data 210 in FIG. 2. Extreme filtration application 302 is shown to be configured as interfacing with, only as a nonlimiting example, test LLM 306 and a production LLM 308. In one embodiment, test LLM 306 is a smaller model relative to production LLM 308. For example, where production LLM 308 might be configured with 8-13 Billion parameters, test LLM might be configured with sub-1-1.4 Billion parameters.

Component 312 performs a data sampling operation on input data 304 and produces sample raw domain data, as described herein. Component 314 receives sample raw domain data from component 312 and either performs one or more tokenization operations on the sample raw domain data or a portion thereof, or interfaces with one or more tokenizing service for the tokenization of sample raw domain data or a portion thereof, or some combination thereof. Through these operations, component 314 produces tokenized sample raw domain data, which includes a set of tokens corresponding to a document in the sample raw domain data.

Component 316 computes a tokens-per-byte ratio for a tokenized document in a manner described earlier. Component 318 computes a tokens-per-character ratio for a tokenized document in a manner described earlier. The operations of components 316 and 318 can be combined in one component within the scope of the illustrative embodiments. Furthermore, component 316 or 318, but not both, may be omitted in an implementation within the scope of the illustrative embodiments.

Component 320 computes a distribution of the sample raw domain data based on the computed tokens-per-byte ratio, tokens-per-character ratio, or both. In some cases, component 322 may be used instead of component 320, or in conjunction with component 320, to produce a ranking or ordered list of documents using tokens-per-byte ratio, tokens-per-character ratio, or both, as described herein.

Component 324 computes the one or more extremes in the distribution and/or ranking using one or more threshold values to identify, to wit, the documents that lie at the extremes of the distribution or ranking, in a manner described herein. Component 324 removes the documents that are in the extremes and produces interim filtered data. Component 324 uses test LLM 306 to determine whether the interim filtered data improves an output of test LLM 306. If test LLM provides a machine learning feedback that the performance has improved, component 324 may further tune a threshold to try and further improve the performance until the improvements either reverse or stagnate. Similarly, if test LLM 306 provides a machine learning feedback that the performance has deteriorated, component 324 may roll back a threshold to a previous value or a different value to try and improve the performance.

Once the performance of test LLM 306 is determined to be satisfactory, or further improvements not computationally desirable, component 326 outputs a final version of filtered data in the form of filtered data 328. Filtered data 328 is then usable for training production LLM 308.

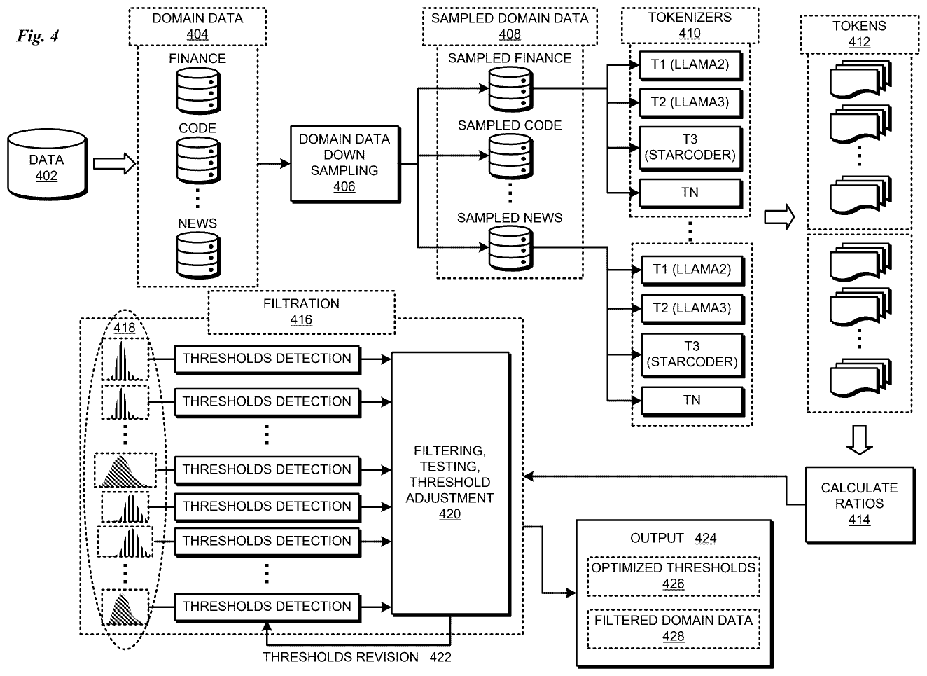

With reference to FIG. 4, this figure depicts a block diagram of an example operation of an extreme filtration application in accordance with an illustrative embodiment. For example, extreme filtration application 302 of FIG. 3 may be configured to perform some or all of the operations depicted in FIG. 4. Data 402 is analogous to raw data corpus 202. The extreme filtration application constructs raw domain data 404 as described herein. Component 312 performs down sampling 406 using raw domain data 404 and produces sample raw domain data 408. Sample raw domain data 408 may include categories and subcategories. In this example nonlimiting depiction, component 314 utilizes a common set or different sets of external tokenizers 410 for tokenizing the sample raw domain data of different domains. Tokenizers 410 produce tokens 412, which includes a set of tokens corresponding to the sample raw domain data of each domain that is tokenized in this manner.

Components 316 and 318 compute ratios 414 by performing the computations of tokens-per-byte ratio, tokens-per-character ratio, or both, using tokens 412. The tokenized domain data and the corresponding computed ratios 414 are passed for filtration 416. Filtration operation 416 computes distributions 418. The illustrative embodiments recognize that different tokenizers can tokenize the same document differently, causing a collection of documents to distribute differently in a distribution graph or ordered list. Similarly, the illustrative embodiments recognize that the distribution or ordered list might look different for the same data set depending on whether the tokens-per-byte ratio or the tokens-per-character ratio is used for the distribution. For this reason, a distribution of tokenized data is depicted differently in distributions 418 to depict a correspondence with a particular tokenizer that was used in tokenizing that domain data, a type of ratio that was used, or both.

Filtration operation 416 obtains one or more threshold values in one of the manners described earlier, corresponding to each distribution in distributions 418. Filtration operation 416 applies the one or more thresholds to a corresponding distribution in distributions 418.

Filtering, testing, and threshold adjustment operations 420 occur in a manner described with reference to FIG. 3. Iterative threshold revisions 422 to one or more thresholds are computed in operations 420 and utilized to arrive at optimized values of one or more thresholds, as the case may be depending on the number of domains in the data, type of distribution(s) used, number and types of tokenizers used, or some combination of these and other factors. Filtration operation 416 produces output 424, which may include a set of one or more optimized threshold values 426, filtered data 428 pertaining to one or more domains, or both. In one embodiment, filtered data 428 is not delineated along domains. in another embodiment, various domains are delineated in filtered data 428.

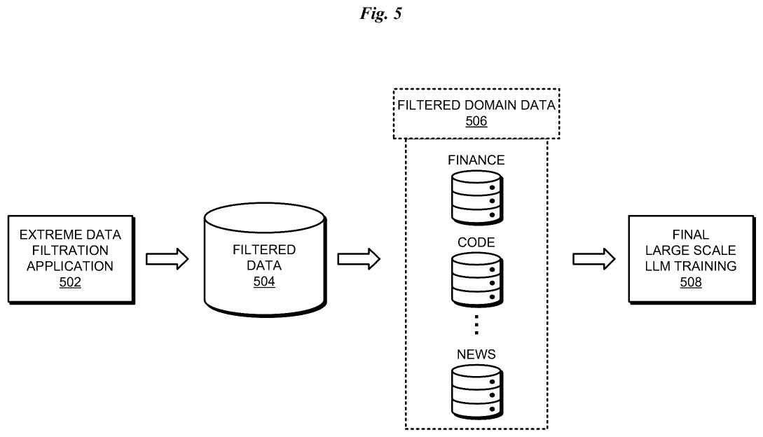

With reference to FIG. 5, this figure depicts one example process for improved LLM training using filtered data in accordance with an illustrative embodiment. Extreme filtration application 502 is an example of extreme filtration application 302 in FIG. 3. Through a process similar to the depiction of FIG. 4, extreme filtration application 502 produces filtered data 504. If filtered data 504 does not include domain delineation, filtered data 504 is categorized into different domains to create filtered domain data 506. Filtered domain data 506 serves as a training input to train a large scale LLM 508.

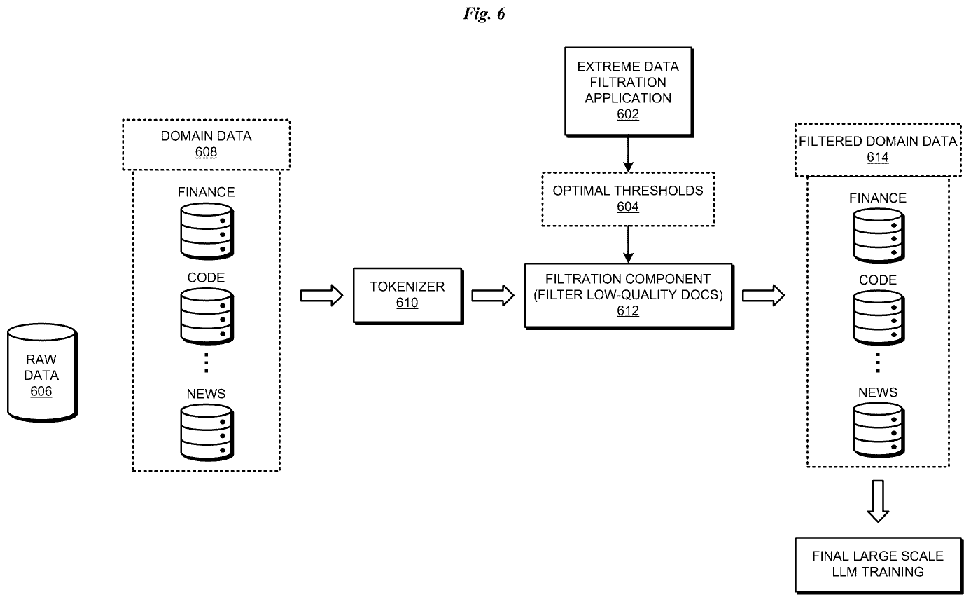

With reference to FIG. 6, this figure depicts another example process for improved LLM training in accordance with an illustrative embodiment. Extreme filtration application 602 is an example of extreme filtration application 302 in FIG. 3, and produces a set of one or more optimal threshold values 604 int ch manner of optimal thresholds 426 in FIG. 4.

In some cases, it may be desirable to obtain raw data anew for LLM training, i.e., obtain raw data 606 that is different from the raw data used by extreme filtration application 602 for computing optimal thresholds 604. Raw data 606 is categorized into raw domain data 608 of one or more different domains. a tokenizer 610 corresponding to an optimal threshold 604 is used to filter raw domain data 608 of a domain. Again, more than one tokenizer 610 can be used with corresponding one or more optimal thresholds 604 with raw domain data 608 of one or more domains within the scope of the illustrative embodiments.

Filtration operation 612 uses optimal threshold(s) 604 with the tokenized domain data produced from tokenizer(s) 610 to filter out low quality documents in a manner described herein. Filtered domain data 614 is a product of filtration operation 612, and may include filtered data pertaining to one or more domains. filtered domain data 614 is used for training 616 of a large scale LLM, such as production LLM 308 in FIG. 3.

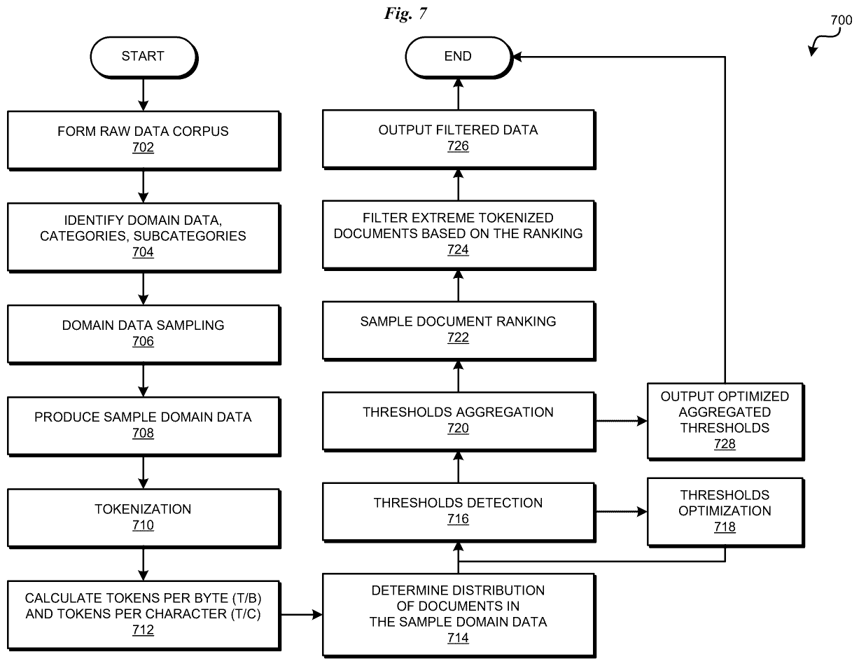

With reference to FIG. 7, this figure depicts a flowchart of an example process for training data filtration for large language models in accordance with an illustrative embodiment. Process 700 can be implemented using extreme filtration application 302 of FIG. 3.

Process 700 begins with forming a raw domain data (step 702). The process identifies one or more domain data, categories, subcategories, or some combination thereof in the raw domain data (step 704). The process samples the raw domain data (step 706). The process outputs sample raw domain data as described herein (step 708). The process tokenizes the sample raw domain data using one or more tokenizers or tokenizing operations as described herein (step 710). The process computes the tokens-per-byte ratio, the tokens-per-character ratio, or both, using the tokenized sample domain data (step 712).

The process determines a distribution of the documents in the tokenized sample domain data using the tokens-per-byte ratio, tokens-per-character ratio, or both (step 714). The process performs threshold(s) detection using one or more initial threshold values obtained using any of the possible methods (step 716). The process revises the threshold values iteratively to achieve threshold optimization as described herein (step 718).

Once thresholds have been optimized for all the different distributions for all the different tokenizers and ratios for a given domain data, the process aggregates the threshold values for that sample domain data (step 720). For example, if for one sample domain data, one tokenizer's distribution identified documents A, B, C, and D for exclusion due to low quality, another tokenizer's distribution identified documents A, B, E, and X for exclusion, and another tokenizer's distribution identified documents A, B, and C for exclusion, aggregation step 720 would identify the optimized aggregated threshold such that documents A and B are excluded and not C, D, E, or X. the process may also perform a ranking of the documents in the sample domain data (step 722). The process filters out, removes, makes unavailable, or otherwise excludes the extreme documents-documents lying outside of the optimized aggregated threshold (step 724). The process outputs the filtered data thus created (step 726). The process ends thereafter.

In one embodiment, process 700 at step 718 may also output a set of one or more optimized aggregated thresholds to be used in the manner depicted in FIG. 6 (step 728).

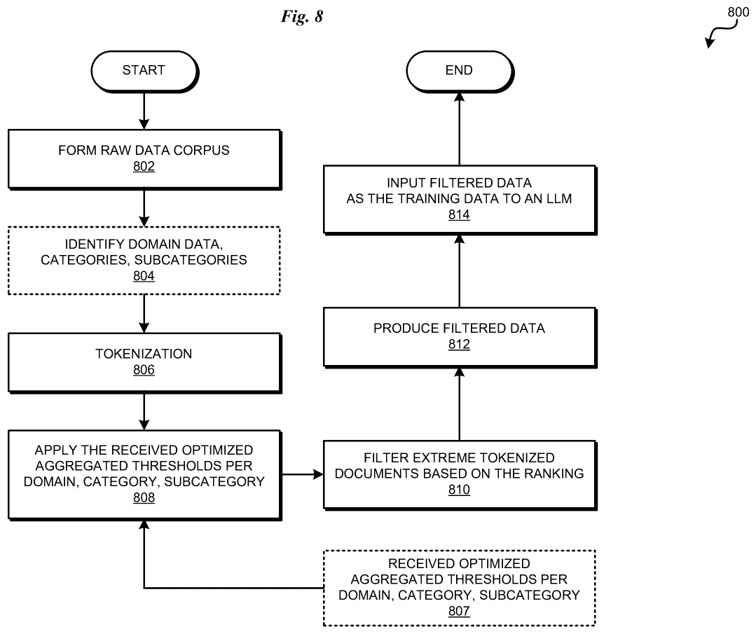

With reference to FIG. 8, this figure depicts a flowchart of an example process for training data filtration for large language models in accordance with an illustrative embodiment. Process 800 may be implemented in the manner of the configuration depicted in FIG. 6.

The process begins with forming a raw domain data (step 802). The process identifies one or more domain data, categories, subcategories, or some combination thereof in the raw domain data (step 804). The process tokenizes the raw domain data using one or more tokenizers or tokenizing operations as described herein (step 806). The process receives optimized aggregated threshold value(s) per domain, per category in the domain, per subcategory, as the case may be in a particular implementation (step 807). The process applies the received optimized aggregated thresholds to the tokenized domain data (step 808).

The process filters out, removes, makes unavailable, or otherwise excludes the extreme documents-documents lying outside of the optimized aggregated threshold (step 810). The process outputs the filtered data thus created (step 812). The process inputs the filtered data as the training data for training an LLM (step 814). The process ends thereafter.

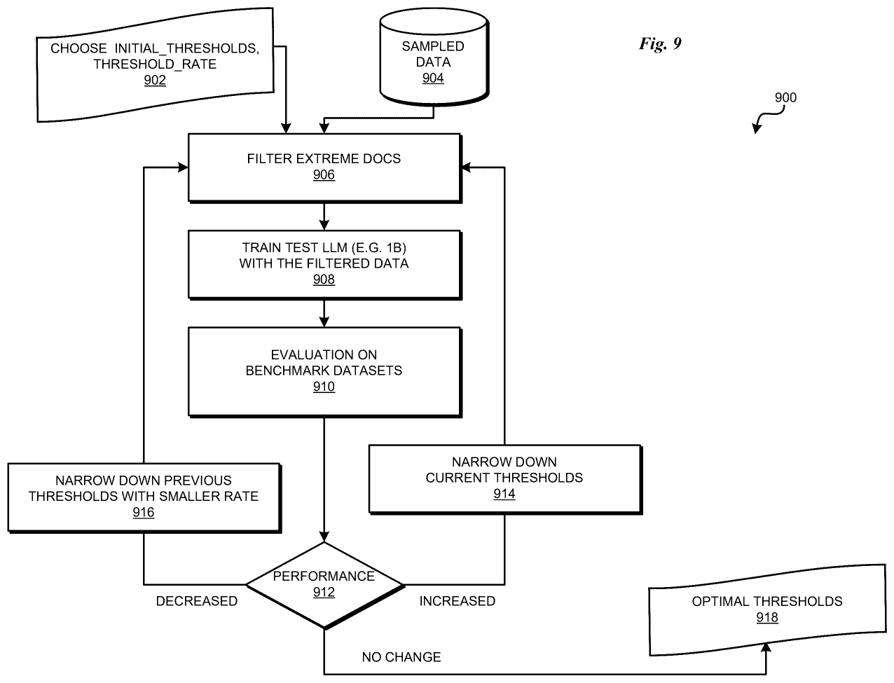

With reference to FIG. 9, this figure depicts a flowchart of an example process for generating optimal thresholds in accordance with the illustrative embodiments. Process 900 can be implemented as step 718 in process 700 of FIG. 7. A user, a profile, a system, a default value, a feedback loop from an LLM, or some combination thereof provides one or more initial threshold value (902). Oen or more data sources provide raw data which is then sampled to form sample data (904).

Using the initial thresholds and the sample data, some extreme documents are filtered out (906). The remaining documents form a filtered data set. A test LLM is trained using the filtered data set (908). In one example implementation, the test LLM is a small, 1.4 Billion parameters model, but the test LLM may be of any suitable size or complexity without departing the scope of the illustrative embodiments.

The performance of the thus trained test LLM is evaluated using one or more benchmark dataset (910) to determine whether the filtered data set improved or decreased relative to the performance using the benchmark data set (912). If the performance increased, the threshold value(s) used in the last iteration are narrowed, i.e., adjusted in a manner that more documents would fall outside the adjusted threshold and be filtered out as low quality as compared to the previous iteration (914). If the performance decreased, the threshold value(s) used in the last iteration are broadened, ie, adjusted in a manner that fewer documents would fall outside the adjusted threshold and be filtered out as low quality as compared to the previous iteration (916).

A revised set of low quality documents are filtered out (returning to 906) and the process 906-912 performed in another iteration. When the performance of the test LLM remains unchanged, to wit, not changing by more than a tolerance value in either direction relative to the performance int eh previous iteration, the last used threshold value(s) are output as optimal threshold(s) (918).

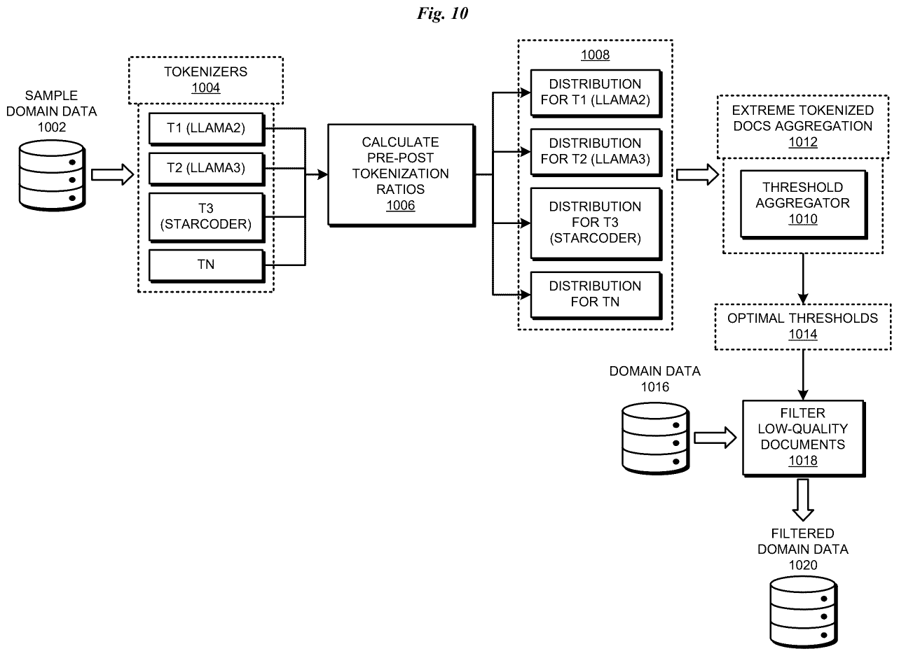

With reference to FIG. 10, this figure depicts a process for training data filtration for large language models in accordance with an illustrative embodiment. Extreme filtration application 302 can be configured to perform operations in the manner of FIG. 6 to perform the depicted process.

Sample domain data 1002 is tokenized using a set of tokenizers 1004. From the post-tokenization tokenized domain data and the pre-tokenization sample domain data, the tokens-per-byte ratio and the tokens-per-character ratio are calculated. Using the ratios corresponding to each tokenizer used, a corresponding distribution of the documents in the sample domain data is constructed. A set 1008 of distribution is thus constructed.

Starting from initial threshold values and subsequently using iteratively revised threshold values, the tokenized documents at the extremes of the distributions are removed at each iteration using threshold aggregation. Threshold aggregator 1010 aggregates the thresholds for various tokenizers operating on the same domain data to order or distribute the documents in an aggregate manner (1012). From the aggregate ordering or distribution of the documents the low quality documents according to the aggregate thresholds are removed or filtered out.

The optimal threshold values 1014 are supplied to a filtering application, such as a version of extreme filtration application 302. The version of extreme filtration application 302 uses optimal thresholds 1014 on new raw domain data 1016. low quality documents according to the optimal thresholds are filtered out (1018) from domain data 1016. Filtered domain data 1020 is then ready for training an LLM.

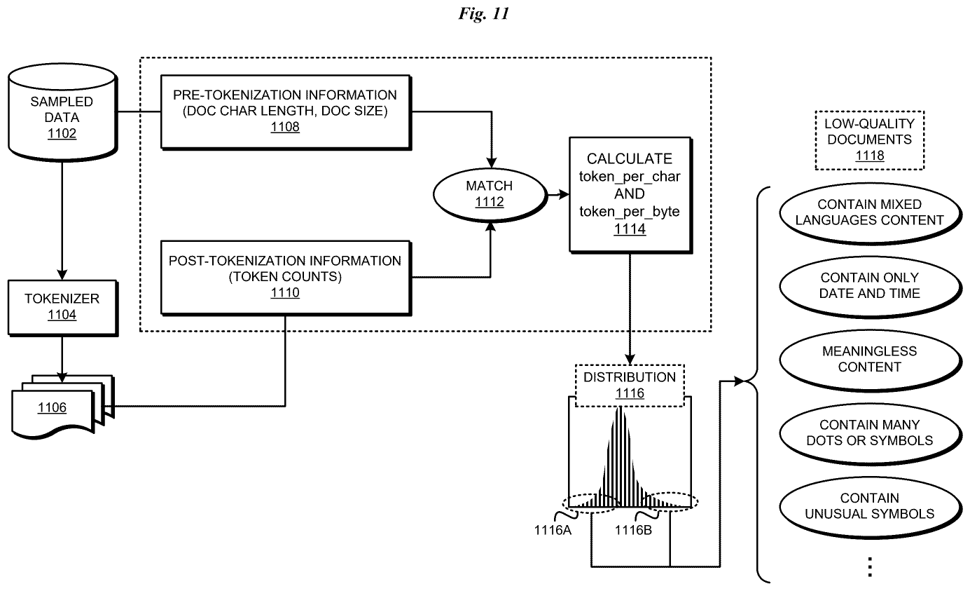

With reference to FIG. 11, this figure depicts a process for identifying low quality documents in accordance with an illustrative embodiment. Sample data 1102 is similar to sample domain data 1002 in FIG. 10. Tokenizer 1104 is one example tokenizer from tokenizers 1004 and produces tokens 1106 corresponding to sample domain data 1102. Component 1108 computes the pre-tokenization attributes of a raw document in sample data 1102, e.g., the document's length in number of characters, document's size in number of bytes, and other similarly usable attributes, such as word count.

Component 1110 computes a post-tokenization attribute of the tokenized document, e.g., the token count corresponding to the document. A pre-tokenization attribute of a document is matched (1112) with a post-tokenization attribute of the same document. Component 1114 calculates one or more ratios, such as the tokens-per-byte ratio and/or the tokens-per-character ratio, using the matched pre and post tokenization attributes for the document. A set of documents from the sample data 1102 are tokenized and their corresponding ratios computed in this manner.

Using one or more of the computed ratios for the set of documents, distribution 1116 is prepared to identify documents lying in regions 1116A, or 1116B, or both 1116A and 1116B, of the distribution graph. The boundaries of regions 1116A and 1116B are defined by the thresholds described herein. Documents lying in regions 1116A, or 1116B, or both 1116A and 1116B, of the distribution graph are classified as low quality documents 1118 and may be filtered out from sample data to form filtered data as described herein. Some nonlimiting examples of low quality documents 1118 are non-exhaustively listed herein and depicted in FIG. 11.

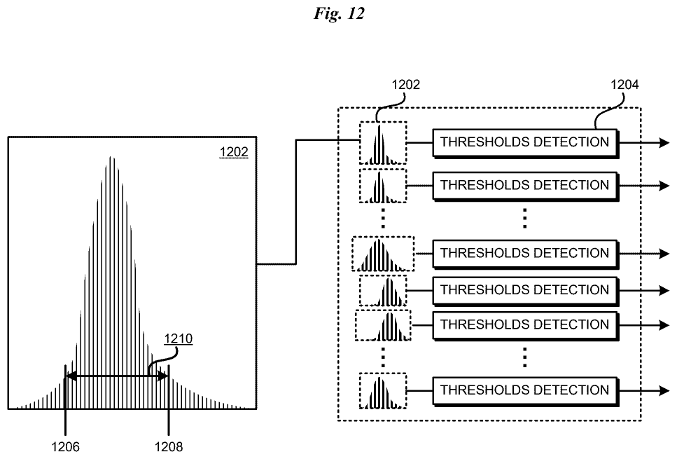

With reference to FIG. 12, this figure depicts a document distribution usable in accordance with an illustrative embodiment. Distribution 1202 is one example distribution for one example tokenizer with one ratio, for example tokens-per-byte ratio, applied thereto, in a set of distributions, as shown. Threshold detection function as described herein uses a set of threshold values—initially received or subsequently computed—to identify threshold boundaries 1206 and 1208 in distribution 1202 as shown. Documents in region 1210 of distribution 1202 are desirable and to be retained in the filtered data and documents in regions from a boundary to a nearest end of the distribution are to be filtered out as low quality documents.

It should be understood that within the scope of the illustrative embodiments, any operation described with reference to a document can similarly be applied to a collection—or, buckets—of documents. In other words, a collection or bucket of data can be treated together in the same manner as a document in a given embodiment, and such modification of an embodiment is contemplated within the scope of the illustrative embodiments.

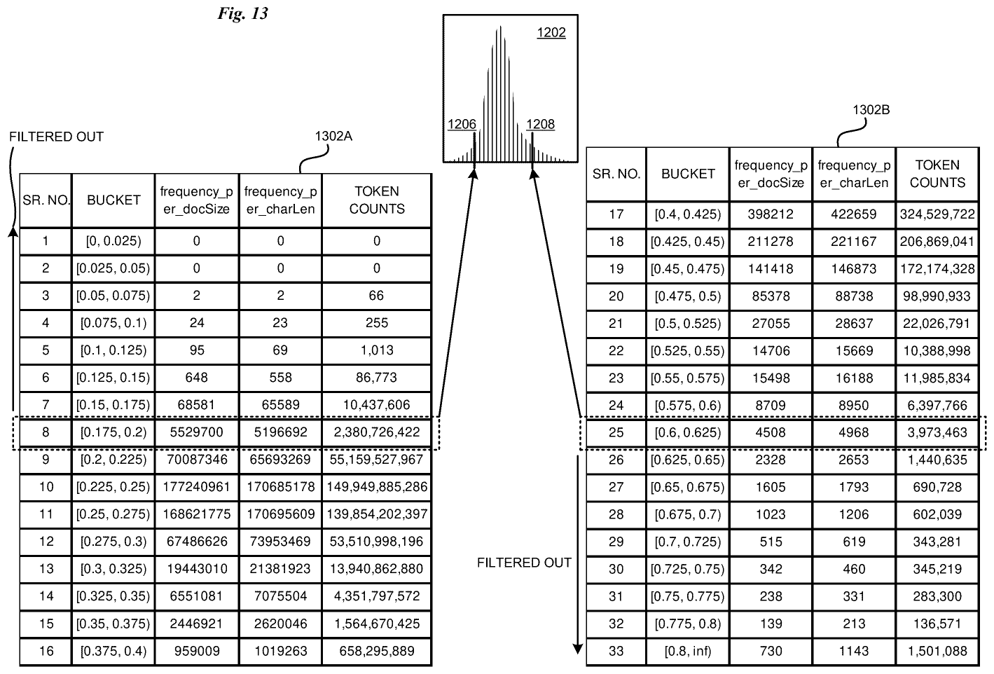

With reference to FIG. 13, this figure depicts an example operation using the document distribution depicted in FIG. 12. The first column in FIG. 13 shows sr.no. The second column shows the bucket intervals, which evenly divide the distribution in 1202 into 33 buckets, each bucket containing one or more documents. The third and forth columns show the number of documents falling in each of the corresponding buckets respectively computing by tokens-per-byte and tokens-per-character ratios. The last column show their total token counts with respect to the documents selected by tokens-per-byte ratio. The token counts column in 1302 corresponds to the total number of tokens counted for the number of documents shown in frequency_per_docSize (Note that, a similar column for frequency_per_charLen is not shown in this table).

For example, analyzing a sample data set comprising multiple documents results in a distribution over their token-per-character values depicted in 1202. This distribution is evenly divided into 33 buckets/intervals with statistics per each bucket (second column) are depicted in 1302A and 1302B (the single table has been broken up into two portions in this depiction only for clarity). Using distribution 1202 and thresholds 1206 and 1208, as can be seen, all documents having tokens-per-byte (or tokens-per-character) value from sr. no. 1-8 fall outside and including the threshold 1206. They are considered the left extreme (poor quality) documents and can be filtered out. Similarly, documents having tokens-per-byte (or tokens-per-character) from sr. no. 25-33 fall outside and including the threshold 1208. They are considered the right extreme (poor quality) documents and can be filtered out too.

The tokens-per-byte ratio has been used to count the number of documents falling in each bucket in table 1302 and such document counts are reflected in “frequency_per_docsize” column, along with their total token counts shown in the last column in table 1302. Likewise, the tokens-per-character ratio has been used to count the number of documents falling in to each bucket in table 1302 and such counts are presented in “frequency_per_charlen” As an example, those documents falling into the buckets from 8th backward and 25th forward are considered extreme documents whose contents can be low quality and should be removed from the LLM training dataset. This is because their tokens-per-byte and tokens-per-character ratios are significantly different/deviated from majority of the documents in the same domain/(sub) category.

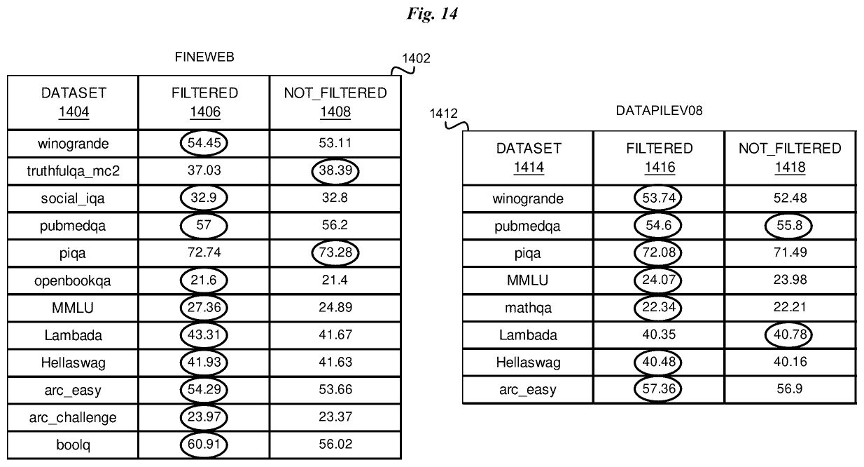

With reference to FIG. 14, this figure depicts comparative results of training two LLMs with identical neural network architectures, using a filtered version and a non-filtered version of several data sets. The LLMs used were large LLMs comprising 1.4 Billion parameters and previously trained on 35 Billion tokens.

A first LLM was trained and performance tested using twelve different datasets as shown in table 1402 where each dataset is a subset of the Fine Web dataset. Column 1404 shows the dataset used, column 1406 shows the performance of the LLM using filtered version of the dataset in a given row, and column 1408 shows the performance of the LLM using the non-filtered version of the dataset in the given row. As can be seen in a vast majority of datasets, LLM Fine Web performed better with the filtered dataset as compared to the non-filtered dataset.

A second LLM was trained and performance tested using eight different datasets as shown in table 1412 where each dataset is a subset of the DataPile dataset. Column 1414 shows the dataset used, column 1416 shows the performance of the LLM using filtered version of the dataset in a given row, and column 1418 shows the performance of the LLM using the non-filtered version of the dataset in the given row. As can be seen in a vast majority of datasets, LLM DataPilev08 performed better with the filtered dataset as compared to the non-filtered dataset.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
sampling from raw data to form sample domain data, representative data pertaining to a domain, wherein the sample domain data comprises a set of documents;
computing a first pre-tokenization attribute of a first document in the set of documents;
tokenizing the first document, the tokenizing generating a first set of tokens corresponding to the first document;
computing a first post-tokenization attribute of the first document;
positioning the first document in a statistical distribution of the set of documents, wherein the statistical distribution is according to a ratio of a pre-tokenization attribute and a post-tokenization attribute of each document in the set of documents;
selecting, from the statistical distribution, a subset of documents such that each member of the subset has a value of the corresponding ratio and the value is below a first threshold configured for the statistical distribution, the subset comprising the first document;
filtering out the subset of documents from the sample domain data such that a second subset comprising documents remaining in sample domain data after the filtering comprises filtered data; and
training a model using filtered data.

2. The computer-implemented method of claim 1, further comprising:
receiving a performance feedback from the training;
revising the first threshold to form a revised threshold; and
using, in the selecting, the revised threshold as the first threshold, the using causing a different subset of documents from the set of documents such that the first document is not a member of the different subset.

3. The computer-implemented method of claim 1, further comprising:
receiving a performance feedback from the training;
determining from the performance feedback that the first threshold is an optimal threshold;
filtering, using the optimal threshold, to form new filtered data, new domain data comprising a new set of documents; and
training a second model using the new filtered data.

4. The computer-implemented method of claim 1, wherein the tokenizing uses a first tokenizer and the first threshold corresponds to the first tokenizer, further comprising:
further tokenizing the set of documents using a second tokenizer, the further tokenizing generating a corresponding second set of tokens for each document in the set of documents;
configuring a second threshold corresponding to the second tokenizer;
computing an aggregate threshold from the first threshold and the second threshold; and
using, in the selecting, the aggregate threshold as the first threshold.

5. The computer-implemented method of claim 1, further comprising:
configuring the threshold for the statistical distribution based on a user input.

6. The computer-implemented method of claim 1, further comprising:
configuring the threshold for the statistical distribution based on a value specified in a system.

7. The computer-implemented method of claim 1, further comprising:
configuring the threshold for the statistical distribution based on a feedback received from the model, the feedback being related to a performance of the model after being trained using the filtered data.

8. The computer-implemented method of claim 1, wherein the statistical distribution is configured with a plurality of thresholds, the plurality of thresholds including the threshold and a second threshold.

9. The computer-implemented method of claim 8, wherein the value of the first ratio of the first document is below the threshold and a value of a second ratio of a second document in the set of documents is below the second threshold, and wherein the second document is also filtered out of the set of documents in forming the filtered data.

10. The computer-implemented method of claim 1, wherein the ratio is a tokens-per-byte ratio computed by dividing the number of tokens by the size of the first document measured in bytes.

11. The computer-implemented method of claim 1, wherein the ratio is a tokens-per-character ratio computed by dividing the number of tokens by the number of characters present in the first document.

12. The computer-implemented method of claim 1, wherein the first post-tokenization attribute of the first document is a number of tokens in the set of tokens corresponding to the first document.

13. The computer-implemented method of claim 1, further comprising:
selecting a tokenizer from a set of tokenizers;
sending the first document via an interface with the tokenizer for the tokenizing; and
receiving from the tokenizer via the interface, the first set of tokens corresponding to the first document.

14. The computer-implemented method of claim 13, wherein the tokenizer is executing in a first data network and wherein the computing the pre-tokenization attribute is executed in a second data network.

15. The computer-implemented method of claim 1, wherein the first pre-tokenization attribute of the first document is a size of the first document measured in bytes.

16. The computer-implemented method of claim 1, wherein the first pre-tokenization attribute of the first document is a size of the first document measured in a number of characters present in the first document.

17. A computer program product comprising:
One or more computer readable storage media; and
program instructions stored on the one or more storage media and configured to perform operations comprising:
sampling from raw data to form sample domain data, representative data pertaining to a domain, wherein the sample domain data comprises a set of documents;
computing a first pre-tokenization attribute of a first document in the set of documents;
tokenizing the first document, the tokenizing generating a first set of tokens corresponding to the first document;
computing a first post-tokenization attribute of the first document;
positioning the first document in a statistical distribution of the set of documents, wherein the statistical distribution is according to a ratio of a pre-tokenization attribute and a post-tokenization attribute of each document in the set of documents;
selecting, from the statistical distribution, a subset of documents such that each member of the subset has a value of the corresponding ratio and the value is below a first threshold configured for the statistical distribution, the subset comprising the first document;
filtering out the subset of documents from the sample domain data such that a second subset comprising documents remaining in sample domain data after the filtering comprises filtered data; and
training a model using filtered data.

18. The computer program product of claim 17, wherein the stored program instructions are stored in a computer readable storage device in a data processing system, and wherein the stored program instructions are transferred over a network from a remote data processing system.

19. The computer program product of claim 17, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
sampling from raw data to form sample domain data, representative data pertaining to a domain, wherein the sample domain data comprises a set of documents;
computing a first pre-tokenization attribute of a first document in the set of documents;
tokenizing the first document, the tokenizing generating a first set of tokens corresponding to the first document;
computing a first post-tokenization attribute of the first document;
positioning the first document in a statistical distribution of the set of documents, wherein the statistical distribution is according to a ratio of a pre-tokenization attribute and a post-tokenization attribute of each document in the set of documents;
selecting, from the statistical distribution, a subset of documents such that each member of the subset has a value of the corresponding ratio and the value is below a first threshold configured for the statistical distribution, the subset comprising the first document;
filtering out the subset of documents from the sample domain data such that a second subset comprising documents remaining in sample domain data after the filtering comprises filtered data; and
training a model using filtered data.
